(19) United States
(12) Patent Application Publication
(10) Pub. No.: US 2025/0257864 A1
(43) Pub. Date: Aug. 14, 2025

(54) SOLID-STATE CANOPY LIGHT FIXTURE WITH HINGED DIFFUSER LENS

(71) Applicant: MaxLite Inc., Pine Brook, NJ (US)

(72) Inventors: Eric Clohosey, East Rutherford, NJ (US); Stephen Entrekin, Chester, NJ (US)

(21) Appl. No.: 19/192,871

(22) Filed: Apr. 29, 2025

Related U.S. Application Data
(60) Provisional application No. 63/348,512, filed on Jun. 3, 2022.

(51) Int. Cl. F21V 17/10; F21V 15/01

(52) U.S. Cl. CPC F21V 17/107; F21V 15/01

(57) ABSTRACT

The invention is a solid-state canopy light fixture featuring a box-shaped housing with a base panel and four side panels that define an interior volume. The top opening allows access to this volume. A hinge member is on the first side panel, while a rib with a hole for a fastener is on the second side panel. The lens tray, with a base tray panel and a continuous side wall, includes a tray hinge member and a tray rib with a second hole. The tray hinge connects to the housing hinge, allowing the lens tray to rotate between two positions. A diffuser lens, secured within the side wall, and a board with solid-state lighting elements are included. A sealing element is adjacent to the lens edge. This design enables easy installation by eliminating the need to fully remove the diffuser lens.

### CROSS-REFERENCE TO RELATED APPLICATION(S)

The present disclosure is related to, and claims priority to, U.S. Provisional Patent Application Ser. No. 63/648,512, titled “SOLID-STATE CANOPY LIGHT FIXTURE WITH HINGED DIFFUSER LENS,” which was filed on May 16, 2024, the entirety of which is incorporated by reference into the present disclosure.

### BACKGROUND

Canopy light fixtures are well known in the prior art. Typically, canopy light fixtures are horizontally mounted, commonly ceiling mounted, to have downward light throw. As such, these light fixtures are well-suited for area lighting and safety lighting, for example, in parking structures, gas stations, buildings, walkways and entryways.

A typical canopy light fixture includes a box-shaped housing to which is mounted a diffuser lens. Installation of the fixture requires physical mounting of the housing with electrical wiring being pulled through one or more access openings in the housing, e.g., through one or more knockout holes. The diffuser lens is removed with standard designs to access the interior of the housing to make necessary electrical connections. Removal and re-mounting of the diffuser lens is time consuming, particularly in large installations where a large quantity of canopy light fixtures is required to be installed.

### SUMMARY

A solid-state canopy light fixture is provided herein including: a box-shaped housing having a base panel, a first side panel, a second side panel, a third side panel, and a fourth side panel, the first, second, third, and fourth side panels perimetrically bounding the base panel such that the base panel and the first, second, third, and fourth side panels collectively define an interior volume, the first, second, third, and fourth side panels defining a top opening, spaced from the base panel, through which the interior volume is accessible; at least one hinge member formed on an exterior surface of the first side panel opposite the interior volume; a rib projecting from an exterior surface of the second side panel opposite the interior volume, a first hole being formed in the rib for receiving a fastener; a lens tray having a base tray panel, with opposing first and second faces, and a continuous side wall bounding the base tray panel, the side wall protruding from the first face, at least one tray hinge member formed on an exterior surface of the side wall opposite the base tray panel, and a tray rib formed on an exterior surface of the side wall opposite the base tray panel, a second hole being formed in the tray rib, wherein the at least one tray hinge member is hingedly connected to the at least one hinge member so that the lens tray is rotatably displaceable between a first position, where the tray rib is adjacent the rib with the second hole being coaxially aligned with the first hole, and a second position, where the tray rib is spaced from the rib with the second hole not being coaxially aligned with the first hole; a diffuser lens having a generally planar outer edge bounding an inner portion, wherein the diffuser lens is secured to the lens tray so that the outer edge is located wholly within the side wall; at least one board containing a plurality of solid-state lighting elements located between the lens and the base tray panel of the lens tray; and, at least one sealing element adjacent the outer edge. Advantageously, the subject invention provides a hinged assembly, containing the diffuser lens and solid-state lighting elements, which avoids the need for full removal of the diffuser lens during installation of the light fixture.

### BRIEF DESCRIPTION OF THE DRAWINGS

FIG. 1 is a top view schematic of the solid-state canopy light fixture illustrating the housing and lens tray assembly.

FIG. 2 is a side view schematic illustrating the assembly of the solid-state canopy light fixture with the hinged lens tray.

FIG. 3 is an exploded view diagram illustrating the assembly components of the solid-state canopy light fixture.

FIG. 4 is a perspective view illustrating the solid-state canopy light fixture's housing and lens tray assembly.

FIG. 5 is a perspective view illustrating the solid-state canopy light fixture's housing and lens tray assembly.

FIG. 6 is a schematic diagram illustrating the rotational connection between the lens tray and housing in the solid-state canopy light fixture.

FIG. 7 illustrates a schematic diagram of the hinged connection between the housing and lens tray in the solid-state canopy light fixture.

FIG. 8 is a perspective view illustrating the lens tray assembly of the solid-state canopy light fixture.

FIG. 9 is a perspective view illustrating the hinge mechanism of the solid-state canopy light fixture.

### DETAILED DESCRIPTION

In the field of lighting, particularly in environments such as parking structures, gas stations, and walkways, canopy light fixtures are commonly used due to their ability to provide broad area illumination. These fixtures are typically mounted horizontally, often on ceilings, to direct light downward. However, the installation and maintenance of traditional canopy light fixtures present several challenges.

One significant issue with conventional canopy light fixtures is the time-consuming process required for installation and maintenance. Typically, these fixtures include a box-shaped housing with a diffuser lens that needs to be removed to access the interior for electrical connections. This removal and reattachment of the diffuser lens can be particularly cumbersome in large installations where numerous fixtures are involved. Additionally, the requirement to fully detach the lens increases the risk of damage to the lens and other components during handling.

Furthermore, traditional designs often lack efficient sealing mechanisms, which can lead to moisture ingress, especially in outdoor or non-climate-controlled environments. This can result in damage to the internal components, reducing the lifespan and reliability of the fixture. The absence of a streamlined method for accessing the interior of the fixture without complete disassembly also complicates routine maintenance and repairs.

The present solution addresses these issues by introducing a solid-state canopy light fixture with a hinged diffuser lens assembly. This design allows for easy access to the interior of the fixture without the need for full removal of the diffuser lens, significantly reducing installation and maintenance time. The fixture comprises a box-shaped housing with a lens tray that is rotatably connected via a hinge mechanism, enabling the lens tray to be moved between open and closed positions. This configuration not only facilitates quick access for electrical connections but also minimizes the risk of damage to the lens and other components. Additionally, the solution incorporates effective sealing elements to prevent moisture ingress, enhancing the durability and reliability of the fixture in various environmental conditions.

With reference to the figures, a solid-state light fixture is shown and generally designated with reference number 10. The light fixture 10 generally includes a housing 12, a lens tray 14, a diffuser lens 16, and at least one board 18 containing a plurality of solid-state lighting elements 20.

The housing 12 is preferably box-shaped with a base panel 22, a first side panel 24, a second side panel 26, a third side panel 28, and a fourth side panel 30. The first, second, third, and fourth side panels, 24, 26, 28, 30 perimetrically bound the base panel 22 such that the base panel 22 and the first, second, third, and fourth side panels, 24, 26, 28, 30 collectively define an interior volume 32. In addition, the first, second, third, and fourth side panels, 24, 26, 28, 30 define a top opening 34, spaced from the base panel 22, through which the interior volume 32 is accessible.

The housing 12 may be formed of polymeric material, such as plastic, and be formed by molding, such by injection molding. Alternatively, the housing 12 may be formed partially or wholly of metallic material, e.g., aluminum, and may be die cast. The first, second, third, and fourth side panels, 24, 26, 28, 30 may be joined to form a continuous wall about the base panel 22.

One or more access openings 36 may be formed in the base panel 22 and/or in one or more of the first, second, third, and fourth side panels, 24, 26, 28, 30. The access openings 36 may be of any form known in the art allowing for the passage of wiring, mounting of sensors (e.g., motion sensors, daylight sensors), and connections with auxiliary components, such as back-up batteries. For example, the access openings 36 may be knockout holes and/or threaded openings. Caps (e.g., threaded caps) or removable tabs 38 may be provided to seal the access openings 36 not in use.

The housing 12 may also include one or mounting holes formed, e.g., formed in the base panel 22, to allow the passage therethrough of mounting elements 39, such as screws, brackets, hooks, hangers, and so forth. In addition, or alternatively, the housing 12 may include one or more mounting formations, such as ribs, channels, depressions, and so forth, formed to mountingly engage one or more external mounting elements 39, such as brackets, hooks, hangers, mounting plates, and the like.

At least one hinge member 40 is formed on an exterior surface 42 of the first side panel 24 opposite the interior volume 32. Preferably, two of the hinge members 40 are provided spaced apart on the exterior surface 42.

A rib 44 projects from an exterior surface 46 of the second side panel 26. A first hole 48 is formed in the rib 44 for receiving a fastener. Preferably, the second side panel 26 is located opposite the first side panel 24 across the base panel 22. With the second side panel 26 opposite the first side panel 24, the rib 44 is located opposite the at least one hinge member 40 across the base panel 22. As will be appreciated by those skilled in the art, alternatively, the second side panel 26 may be located adjacent to the first side panel 24, so as not to be opposite the first side panel 24.

The lens tray 14 includes a base tray panel 50, with opposing first and second faces 52, 54, and a continuous side wall 56 bounding the base tray panel 50. The side wall 56 protrudes from the first face 52. Preferably, the side wall 56 protrudes from the first face 52 more than the thickness of the outer edge of the diffuser lens 16 so that the outer edge of the diffuser lens 16 is wholly recessed within the side wall 56 with the diffuser lens 16 secured to the lens tray 14.

At least one tray hinge member 58 is formed on an exterior surface 60 of the side wall 56 opposite the base tray panel 50. Preferably, the same quantity of tray hinge members 58 is provided to correspond to the hinge members 40. In addition, a tray rib 62 is formed on the exterior surface 60 of the side wall 56 opposite the base tray panel 50, with a second hole 64 being formed in the tray rib 62.

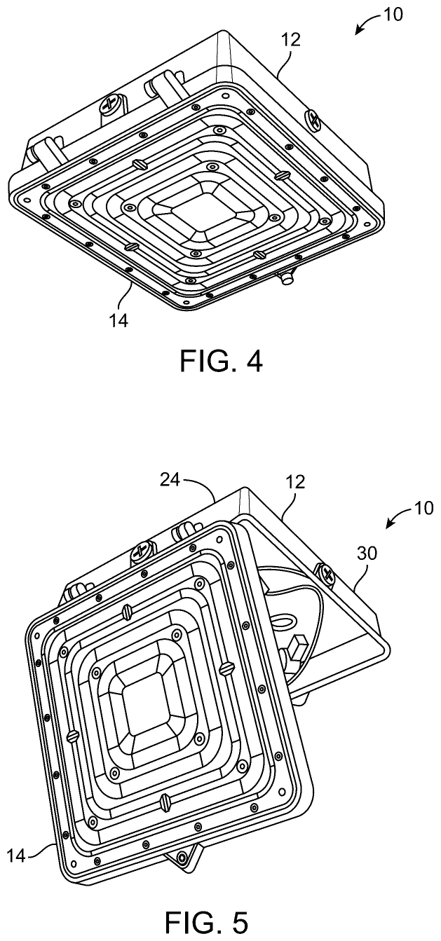

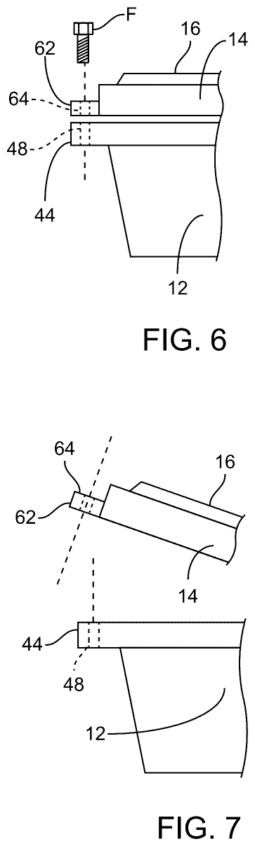

The at least one tray hinge member 58 is hingedly connected to the at least one hinge member 40 so that the lens tray 14 is rotatably displaceable, relative to the housing 12, between a first position, where the tray rib 62 is adjacent the rib 44 with the second hole 64 being coaxially aligned with the first hole 48 (FIGS. 4 and 6), and a second position, where the tray rib 62 is spaced from the rib 44 with the second hole 64 not being coaxially aligned with the first hole 48 (FIGS. 5 and 7). With the lens tray 14 in the first position, a fastener F may be inserted through the second hole 64 and into the first hole 48 to releasably lock the lens tray 14 in a closed position on the housing 12. In the second position, the lens tray 14 is in an open position allowing access to the interior volume 32.

The first hole 48 may be a through-hole formed to extend through the rib 44 or a blind hole not extending through the rib 44. In addition, the first hole 48 and/or the second hole 64 may be internally threaded. As a through-hole, the fastener F may extend through both the first hole 48 and the second hole 64, with a nut or similar structure being secured to the fastener F below the first hole 48 to resist removal of the fastener F. The head of the fastener F may be brought into tight engagement with the tray rib 62 with tightening of a nut on the fastener F below the first hole 48. Alternatively, as a blind hole, the first hole 48 may be internally threaded to threadedly receive the fastener F. The length of the fastener F may be selected such that the fastener F may threadedly engage the first hole 48 and be tightened into engagement with the tray rib 62. Further, alternatively, the first hole 48 may be a through hole and internally threaded allowing the fastener F to extend through the first hole 48 and be threadedly received by the first hole 48 without the need for the use of a nut (as shown in FIG. 2).

The hinge connection between the at least one hinge member 40 and the at least one tray hinge member 58 may be formed in any known manner. By way of non-limiting example, each hinge member 40 corresponds to a tray hinge member 58 with a pin 66, being provided on one of the members, and a matching pin opening 68, being provided on the other of the members, formed to receive the pin 66 so that the pin 66 is rotatable relative to the pin opening 68. The pin defines an axis of rotation about which the lens tray 14 rotates relative to the housing 12. A locking detent 70 may be formed on the pin 66 configured to by-pass the pin opening 68 with sufficient insertion of the pin 66 into the pin opening 68 thereby resisting withdrawal of the pin 66 from the pin opening 68. The locking detent 70 may be ramped to increase in diameter in the direction of insertion of the pin 66 into the pin opening 68. The pin 66 is mounted at a terminal end 72 secured to the respective member. Preferably, a flange 74 radiates outwardly from the pin 66 to act as a stop against excessive insertion of the pin 66 into the pin opening 68 and to act as a guide surface about the pin opening 68 during rotation of the lens tray 14 between the first and second positions.

As will be appreciated by those skilled in the art, with two or more pairs of the hinge members 40 and tray hinge members 58, the pins 66 of the respective pairs are preferably coaxially aligned to lie along, and collectively define, the axis of rotation about which the lens tray 14 rotates relative to the housing 12.

The diffuser lens 16 may be of any form known in the art, preferably being translucent. The diffuser lens 16 includes a planar outer edge 76 bounding an inner portion 78. The diffuser lens 16 is secured to the lens tray 14 so that the outer edge 76 is located wholly within the side wall 56 of the lens tray 14. Preferably, the diffuser lens 16 is secured to the lens tray 14 by fasteners extending through the outer edge 76 of the diffuser lens 16 into engagement with the base tray panel 50 of the lens tray 14.

The at least one board 18 may be one or more circuit boards of any known type, including printed circuit boards (PCB's). The solid-state lighting elements 20 are mounted to the at least one board 18 in any known manner so as to be ready for activation by application of electrical power to inputs on the at least one board 18. Any related wiring may be contained within the board 18 as is known in the art.

The solid-state lighting elements 20 may be any type of solid-state lighting elements, such as light emitting diodes (LED's), organic light emitting diodes (OLED's), and polymer light emitting diodes (PLED's).

The at least one board 18 is located between the diffuser lens 16 and the lens tray 14, particularly between the diffuser lens 16 and the base tray panel 50. The at least one board 18 is situated to direct light generated by the solid-state lighting elements 20 at the diffuser lens 16.

The diffuser lens 16 is secured to the lens tray 14 preferably by fasteners extending through the outer edge 76 and into engagement with the lens tray 14, particularly the base tray panel 50. It is preferred that the at least one board 18 be located wholly within the outer edge 76 (i.e., located wholly in alignment with the inner portion 78 of the diffuser lens 16).

With the light fixture 10 being useable in outdoor or non-climate-controlled environments, sealing may be necessary to inhibit the ingress of moisture into internal spaces. It is preferred that at least one sealing element 80 be provided adjacent the outer edge 76, particularly with the diffuser lens 16 secured to the lens tray 14. The sealing element 80 may be located about the perimeter of the outer edge 76 and/or between the outer edge 76 and the base tray panel 50. The sealing element 80 acts to inhibit the ingress of moisture into the space between the diffuser lens 16 and the base tray panel 50. The sealing element may be a continuous gasket formed to extend along the full length of the outer edge 76 of the diffuser lens 16.

In addition, at least one sealing element 82 may be provided to bound the top opening 34 configured to be in sealing contact with the lens tray 14 with the lens tray 14 in the first position. The sealing element 82 inhibits the ingress of moisture into the interior volume 32 with the lens tray 14 being in a closed state.

One or more access openings 84 may be formed in the lens tray 14. Preferably, an access opening 84 is formed in the base tray panel 50, which is spaced from the side wall 56. The access opening 84 allows for wiring to be extended from the interior volume 32 and into electrical connection with the at least one board 18. Slack may be provided in this wiring to allow the lens tray 14 to be rotated to an open state (the second position).

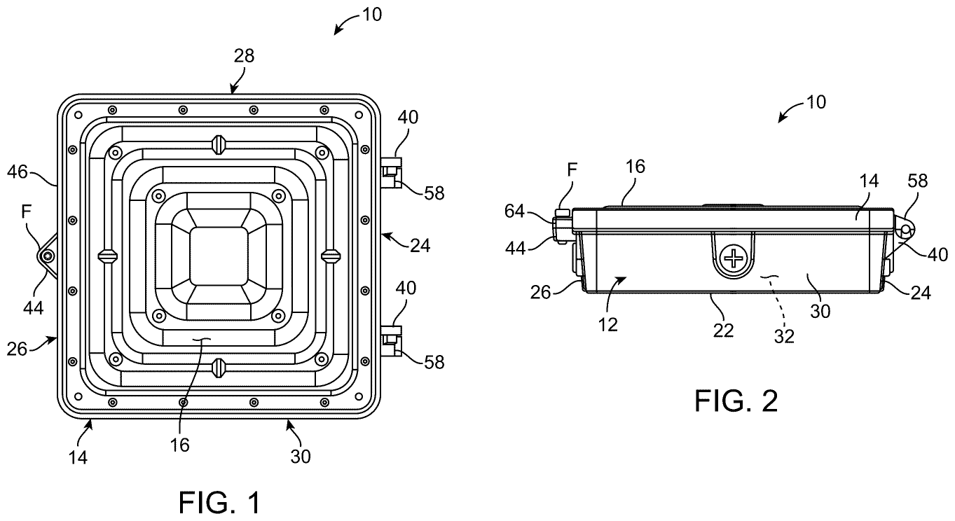

FIG. 1 shows a top view schematic of the solid-state canopy light fixture 10, illustrating the housing 12 and lens tray assembly. The light fixture 10 comprises a lens tray 14, a diffuser lens 16, a first side panel (FSP) 24, a second side panel (SSP) 26, a third side panel (TSP) 28, a fourth side panel (FSP) 30, a hinge member 40, a rib 44, an exterior surface 46, a tray hinge member (THM) 58, and a fastener F.

The lens tray 14 serves as a foundation for the diffuser lens 16. The design of the lens tray 14 ensures that the diffuser lens 16 is held securely, promoting even distribution of light emitted from the solid-state lighting elements. The lens tray 14 is attached to the housing 12, enabling rotational movement through the hinge member 40 and the tray hinge member 58. The diffuser lens 16 is positioned in the center of the lens tray 14 and is designed to spread the light emitted from the solid-state lighting elements housed within the light fixture 10. The diffuser lens 16 is held in place within the lens tray 14, ensuring that the outer edge is recessed within the side wall of the lens tray 14, providing protection and enhancing the aesthetic appeal of the fixture.

The first side panel 24, second side panel 26, third side panel 28, and fourth side panel 30 collectively form the perimeter of the housing 12, enclosing the interior volume of the light fixture 10. These panels contribute to the structural integrity of the fixture, providing a robust enclosure for the internal components. The hinge member 40 is located on the exterior surface of the first side panel 24 and allows the lens tray 14 to rotate. This hinge mechanism, in conjunction with the tray hinge member 58, enables the lens tray 14 to move between open and closed positions, facilitating convenient access to the interior of the fixture for maintenance and installation purposes.

The rib 44 projects from the exterior surface 46 of the second side panel 26 and is designed to receive the fastener F. The fastener F is used to secure the lens tray 14 in a closed position, ensuring that the fixture remains sealed and protected from environmental elements. The rib 44 and fastener F work together to provide a secure locking mechanism for the lens tray 14. The tray hinge member 58 is located on the exterior surface of the lens tray 14 and works in conjunction with the hinge member 40 to allow for the rotational movement of the lens tray 14. This hinge system is designed to provide smooth and reliable operation, ensuring that the lens tray 14 can be easily opened and closed as needed.

FIG. 2 shows a side view schematic of the solid-state canopy light fixture 10, illustrating the housing 12 and lens tray 14 assembly. The light fixture 10 comprises a lens tray 14, a diffuser lens 16, a base panel 22, a first side panel (FSP) 24, a second side panel (SSP) 26, a fourth side panel (FSP) 30, an interior volume 32, a hinge member 40, a rib 44, a tray hinge member (THM) 58, a second hole 64, and a fastener F. The housing 12 forms the structural foundation of the light fixture 10, providing a robust enclosure for the internal components. The housing 12 includes the base panel 22, which serves as the bottom surface, and the first side panel 24, second side panel 26, and fourth side panel 30, which collectively define the perimeter of the housing 12. These panels enclose the interior volume 32, offering protection and support for the components housed within. The base panel 22 is integral to the housing 12, ensuring stability and facilitating mounting of the fixture.

The lens tray 14 is mounted to the housing 12, allowing rotational movement through the hinge member 40 and tray hinge member 58. This hinge mechanism enables the lens tray 14 to move between open and closed positions, facilitating convenient access to the interior volume 32 for maintenance and installation purposes. The diffuser lens 16 is secured within the lens tray 14, ensuring that the outer edge is recessed within the side wall of the lens tray 14, providing protection and enhancing the aesthetic appeal of the fixture. The rib 44 projects from the exterior surface of the second side panel 26 and is designed to receive the fastener F. The fastener F is used to secure the lens tray 14 in a closed position, ensuring that the fixture remains sealed and protected from environmental elements. The rib 44 and fastener F work together to provide a secure locking mechanism for the lens tray 14. The second hole 64 is formed in the rib 44, allowing the fastener F to be inserted and engaged, securing the lens tray 14 to the housing 12. The tray hinge member 58 is located on the exterior surface of the lens tray 14 and works in conjunction with the hinge member 40 to allow for the rotational movement of the lens tray 14. This hinge system is designed to provide smooth and reliable operation, ensuring that the lens tray 14 can be easily opened and closed as needed.

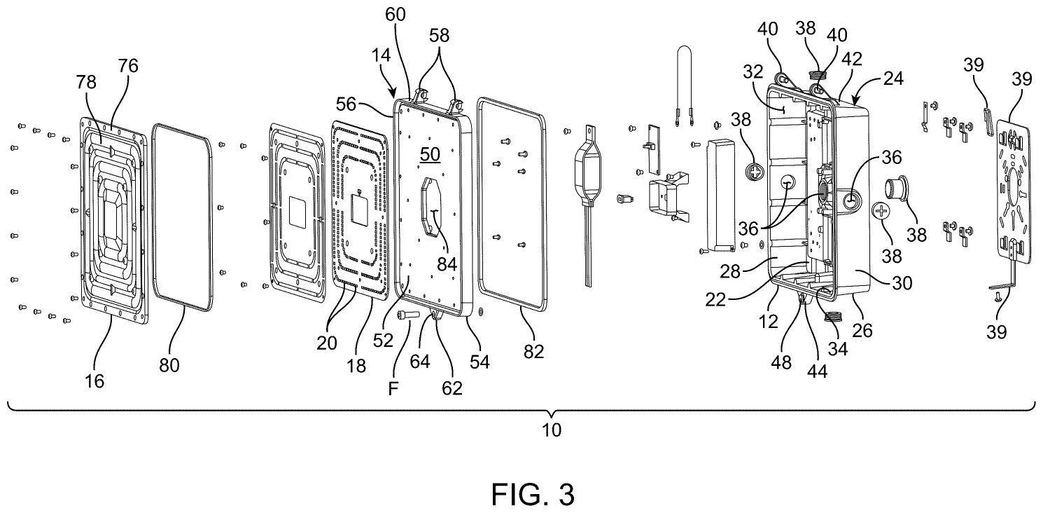

FIG. 3 illustrates an exploded view of the solid-state canopy light fixture 10, showcasing the assembly components. The figure includes a housing 12, a lens tray 14, a diffuser lens 16, a board 18, solid-state lighting elements (SSLE) 20, a base panel 22, a first side panel (FSP) 24, a second side panel (SSP) 26, a third side panel (TSP) 28, a fourth side panel (FSP) 30, an interior volume 32, a top opening 34, access openings 36, removeable tabs 38, mounting elements 39, a hinge member 40, an exterior surface 42, a rib 44, a first hole 48, a base tray panel (BTP) 50, a first face 52, a second face 54, an exterior surface 60, a tray hinge member (THM) 58, a tray rib 62, a second hole 64, an outer edge 76, an inner portion 78, a sealing element 80, a sealing element 82, and an access opening 84.

The housing 12 forms the structural foundation of the light fixture 10, providing a robust enclosure for the internal components. The housing includes the base panel 22, which serves as the bottom surface, and the first side panel 24, second side panel 26, third side panel 28, and fourth side panel 30, which collectively define the perimeter of the housing 12. These panels enclose the interior volume 32, offering protection and support for the components housed within. The top opening 34 allows access to the interior volume 32, facilitating installation and maintenance. The lens tray 14 is mounted to the housing 12, allowing rotational movement through the hinge member 40 and tray hinge member 58. This hinge mechanism enables the lens tray 14 to move between open and closed positions, facilitating convenient access to the interior volume 32 for maintenance and installation purposes. The base tray panel 50, featuring a first face 52 and a second face 54, serves as a foundation for the diffuser lens 16 and the board 18. The tray rib 62, with the second hole 64, aligns with the rib 44 and first hole 48 on the housing 12, allowing a fastener F to secure the lens tray 14 in a closed position.

The diffuser lens 16 is secured within the lens tray 14, ensuring that the outer edge 76 is recessed within the side wall of the lens tray 14, providing protection and enhancing the aesthetic appeal of the fixture. The inner portion 78 of the diffuser lens 16 is designed to spread the light emitted from the SSLE 20 housed within the light fixture 10. The sealing element 80 is positioned adjacent to the outer edge 76, inhibiting moisture ingress and protecting the internal components. Additionally, the sealing element 82 bounds the top opening 34, ensuring a secure seal when the lens tray 14 is in the closed position. The board 18 carries the SSLE 20, which are positioned between the diffuser lens 16 and the base tray panel 50. The access opening 84 in the base tray panel 50 allows for wiring to be extended from the interior volume 32 and into electrical connection with the board 18. The access openings 36 in the housing 12 facilitate the passage of wiring and connections with auxiliary components. Removeable tabs 38 are provided to seal the access openings 36 not in use. Mounting elements 39 are used to secure the light fixture 10 to a surface, ensuring stability and proper alignment.

FIG. 4 shows a perspective view illustrating the solid-state canopy light fixture 10, which comprises a housing 12 and a lens tray 14. The light fixture 10 is designed to provide efficient illumination in various environments, such as parking structures and walkways. The housing 12 serves as the structural foundation of the light fixture 10, while the lens tray 14 is mounted to the housing 12, allowing for rotational movement. The housing 12 is box-shaped and provides a robust enclosure for the internal components of the light fixture 10. The design aims to protect the components from environmental elements, ensuring durability and reliability. The housing 12 includes features that facilitate mounting and installation, making the housing adaptable for various applications. Additionally, the housing 12 supports the lens tray 14, allowing rotation between open and closed positions for convenient access to the interior volume. The lens tray 14 serves as a component of the light fixture 10, designed to hold the diffuser lens 16 securely. The lens tray 14 is attached to the housing 12 through a hinge mechanism, allowing rotational movement. This design facilitates convenient access to the interior of the fixture for maintenance and installation purposes. The lens tray 14 ensures that the diffuser lens 16 is recessed within the side wall, providing protection and enhancing the aesthetic appeal of the fixture.

FIG. 5 illustrates a perspective view of the solid-state canopy light fixture 10, which comprises a housing 12 and a lens tray 14. The light fixture 10 is designed to provide efficient illumination in various environments, such as parking structures and walkways. The housing 12 serves as the structural foundation of the light fixture 10, while the lens tray 14 is mounted to the housing 12, allowing for rotational movement. The housing 12 is box-shaped and provides a robust enclosure for the internal components of the light fixture 10. The design aims to protect the components from environmental elements, ensuring durability and reliability. The housing 12 includes features that facilitate mounting and installation, making the housing adaptable for various applications. Additionally, the housing 12 supports the lens tray 14, allowing rotation between open and closed positions for convenient access to the interior volume. The lens tray 14 serves as a component of the light fixture 10, designed to hold the diffuser lens securely. The lens tray 14 is attached to the housing 12 through a hinge mechanism, allowing rotational movement. This design facilitates convenient access to the interior of the fixture for maintenance and installation purposes. The lens tray 14 ensures that the diffuser lens is recessed within the first side panel 24, providing protection and enhancing the aesthetic appeal of the fixture. The first side panel (FSP) 24 and the fourth side panel (FSP) 30 are integral parts of the housing 12, contributing to the structural integrity of the light fixture 10. The FSP 24 and FSP 30 are positioned to enclose the interior volume, providing a secure and stable enclosure for the internal components. These panels are designed to withstand environmental stresses, ensuring the longevity and reliability of the light fixture 10.

FIG. 6 shows a schematic diagram illustrating the rotational connection between the lens tray 14 and the housing 12 in the solid-state canopy light fixture. The figure includes the tray rib 62, the second hole 64, the first hole 48, the rib 44, the housing 12, the diffuser lens 16, the lens tray 14, and the fastener F. This configuration demonstrates how the lens tray 14 is secured to the housing 12, allowing for rotational movement between open and closed positions. The tray rib 62 is a component of the lens tray 14, designed to align with the rib 44 on the housing 12. The tray rib 62 includes the second hole 64, which is configured to align with the first hole 48 on the rib 44 when the lens tray 14 is in the closed position. This alignment allows the fastener F to be inserted through the second hole 64 and into the first hole 48, securing the lens tray 14 to the housing 12.

The second hole 64 is formed in the tray rib 62 and is designed to receive the fastener F. When the lens tray 14 is in the closed position, the second hole 64 aligns with the first hole 48 on the rib 44, allowing the fastener F to be inserted and engaged. This configuration ensures that the lens tray 14 is securely fastened to the housing 12, preventing unwanted movement and maintaining the integrity of the fixture. The first hole 48 is located on the rib 44, which projects from the housing 12. The first hole 48 is sized to receive the fastener F, allowing the fastener to engage with the second hole 64 on the tray rib 62. This alignment and engagement provide a secure locking mechanism for the lens tray 14, ensuring that the lens tray remains in the desired position. The rib 44 is a structural component of the housing 12, designed to interact with the tray rib 62 on the lens tray 14. The rib 44 includes the first hole 48, which aligns with the second hole 64 on the tray rib 62 when the lens tray 14 is in the closed position. This alignment allows the fastener F to be inserted and engaged, securing the lens tray 14 to the housing 12.

The housing 12 serves as the structural foundation of the light fixture 10, providing a robust enclosure for the internal components. The housing 12 supports the lens tray 14, allowing for rotational movement between open and closed positions. The rib 44 and first hole 48 are integral parts of the housing 12, facilitating the secure attachment of the lens tray 14. The diffuser lens 16 is also positioned within the housing 12, enhancing the light distribution from the light fixture 10. The tray rib 62 and second hole 64 further contribute to the assembly and functionality of the lens tray 14 within the housing 12. The fastener Fis utilized to secure the components together, ensuring stability and reliability in operation.

The diffuser lens 16 is secured within the lens tray 14, ensuring that the outer edge is recessed within the side wall of the lens tray 14. This design provides protection and enhances the aesthetic appeal of the fixture. The diffuser lens 16 is positioned to spread the light emitted from the solid-state lighting elements housed within the light fixture 10. The lens tray 14 is designed to hold the diffuser lens 16 securely. The lens tray 14 is attached to the housing 12 through a hinge mechanism, allowing rotational movement. This design facilitates convenient access to the interior of the fixture for maintenance and installation purposes. The fastener F is used to secure the lens tray 14 to the housing 12. When the lens tray 14 is in the closed position, the fastener F is inserted through the second hole 64 on the tray rib 62 and into the first hole 48 on the rib 44. This engagement ensures that the lens tray 14 is securely fastened to the housing 12, preventing unwanted movement and maintaining the integrity of the fixture.

FIG. 7 illustrates a schematic diagram of the hinged connection between the housing 12 and the lens tray 14 in the solid-state canopy light fixture. The figure includes the housing 12, the lens tray 14, the diffuser lens 16, the rib 44, the first hole 48, the tray rib 62, and the second hole 64. This configuration demonstrates the rotational connection that allows the lens tray 14 to move between open and closed positions relative to the housing 12. The housing 12 serves as the structural foundation of the light fixture 10, providing a robust enclosure for the internal components. The rib 44 projects from the housing 12 and is designed to interact with the tray rib 62 on the lens tray 14. The first hole 48 is located on the rib 44 and is sized to receive a fastener F, allowing the lens tray 14 to be secured to the housing 12. The lens tray 14 is attached to the housing 12 through a hinge mechanism, allowing rotational movement. The tray rib 62 is a component of the lens tray 14, designed to align with the rib 44 on the housing 12. The tray rib 62 includes the second hole 64, which is configured to align with the first hole 48 on the rib 44 when the lens tray 14 is in the closed position. This alignment allows a fastener F to be inserted through the second hole 64 and into the first hole 48, securing the lens tray 14 to the housing 12. The diffuser lens 16 is secured within the lens tray 14, ensuring that the outer edge is recessed within the side wall of the lens tray 14. This design provides protection and enhances the aesthetic appeal of the fixture. The diffuser lens 16 is positioned to spread the light emitted from the solid-state lighting elements housed within the light fixture 10.

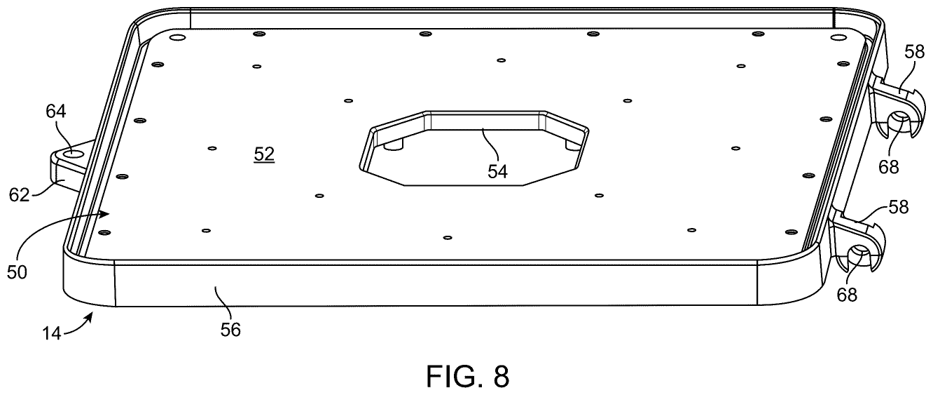

FIG. 8 shows a detailed perspective view of the lens tray 14 of the solid-state canopy light fixture. The lens tray 14 comprises a base tray panel (BTP) 50, a first face 52, a second face 54, a side wall 56, a tray hinge member (THM) 58, a tray rib 62, a second hole 64, and a pin opening 68. This configuration illustrates the structural elements that facilitate the secure attachment and rotational movement of the lens tray 14 within the fixture.

The base tray panel 50 serves as the foundational surface of the lens tray 14, providing support for the diffuser lens 16 and other components. The first face 52 of the BTP 50 is the primary surface that interfaces with the diffuser lens 16, ensuring a stable and secure attachment. The second face 54, located on the opposite side of the BTP 50, is designed to accommodate the solid-state lighting elements and other internal components of the fixture. The side wall 56 extends perpendicularly from the base tray panel 50, forming a continuous border around the perimeter of the lens tray 14. This side wall 56 is configured to maintain the structural integrity of the lens tray 14, providing protection and support for the diffuser lens. The side wall 56 also ensures that the outer edge of the diffuser lens is recessed, enhancing the aesthetic appeal and durability of the fixture.

The tray hinge member 58 is located on the exterior surface of the side wall 56 and is designed to interact with the hinge member on the housing 12. This THM 58 allows for the rotational movement of the lens tray 14, facilitating easy access to the interior of the fixture for maintenance and installation. The pin opening 68 is part of the THM 58, providing a secure point of attachment for the hinge mechanism. The tray rib 62 is an extension of the side wall 56, featuring the second hole 64. This tray rib 62 is designed to align with a corresponding rib on the housing 12, allowing a fastener F to be inserted through the second hole 64 to secure the lens tray 14 in a closed position. This alignment ensures that the lens tray 14 remains securely attached to the housing 12, preventing unwanted movement and maintaining the integrity of the fixture.

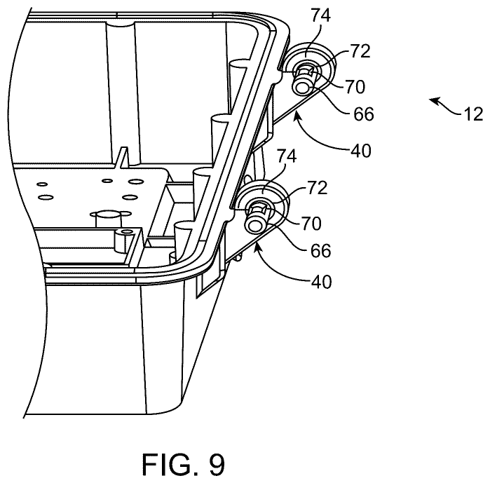

FIG. 9 shows a detailed perspective view of the hinge mechanism in the solid-state canopy light fixture, specifically illustrating the housing 12 and associated components. The figure includes the hinge member 40, pin 66, locking detent 70, terminal end 72, and flange 74, which collectively facilitate the rotational movement of the lens tray relative to housing 12.

The hinge member 40 is a component of the housing 12, designed to support the rotational connection with the lens tray 14. This component provides a stable point of attachment for the pin 66, ensuring smooth and reliable operation. The hinge member 40 is positioned to allow the lens tray 14 to rotate between open and closed positions, facilitating easy access to the interior of the fixture for maintenance and installation. The pin 66 connects the hinge member 40 to the lens tray 14, facilitating rotational movement. The design of the pin 66 ensures a secure fit within the pin opening, creating a pivot point for the lens tray 14. Additionally, the pin 66 includes a locking detent 70, which is arranged to resist withdrawal from the pin opening, thereby maintaining the secure attachment of the lens tray 14 to the housing 12 during operation.

The locking detent 70 is a feature of the pin 66 that enhances the security of the hinge connection. The locking detent is designed to bypass the pin opening with sufficient insertion, preventing accidental disengagement of the pin 66 from the hinge member 40. This mechanism ensures that the lens tray 14 remains in the desired position, maintaining the integrity of the fixture 10. The terminal end 72 of the pin 66 is secured to the hinge member 40, providing a stable point of attachment. The design holds the pin 66 in place, ensuring that the hinge mechanism operates smoothly. The terminal end 72 contributes to the overall stability and reliability of the hinge connection, facilitating the rotational movement of the lens tray 14. The flange 74 radiates outwardly from the pin 66, acting as a stop against excessive insertion into the pin opening. The flange functions as a guide surface during the rotation of the lens tray 14, ensuring that the hinge member 40 operates smoothly and reliably. The flange 74 enhances the structural integrity of the hinge connection, providing additional support and stability.

1. A solid-state canopy light fixture comprising:
a box-shaped housing having a base panel, a first side panel, a second side panel, a third side panel, and a fourth side panel, the first, second, third, and fourth side panels perimetrically bounding the base panel such that the base panel and the first, second, third, and fourth side panels collectively define an interior volume, the first, second, third, and fourth side panels defining a top opening, spaced from the base panel, through which the interior volume is accessible;
at least one hinge member formed on an exterior surface of the first side panel opposite the interior volume;
a rib projecting from an exterior surface of the second side panel opposite the interior volume, a first hole being formed in the rib for receiving a fastener;
a lens tray having a base tray panel, with opposing first and second faces, and a continuous side wall bounding the base tray panel, the side wall protruding from the first face, at least one tray hinge member formed on an exterior surface of the side wall opposite the base tray panel, and a tray rib formed on an exterior surface of the side wall opposite the base tray panel, a second hole being formed in the tray rib, wherein the at least one tray hinge member is hingedly connected to the at least one hinge member so that the lens tray is rotatably displaceable, relative to the housing, between a first position, where the tray rib is adjacent the rib with the second hole being coaxially aligned with the first hole, and a second position, where the tray rib is spaced from the rib with the second hole not being coaxially aligned with the first hole;
a diffuser lens having a generally planar outer edge bounding an inner portion, wherein the diffuser lens is secured to the lens tray so that the outer edge is located wholly within the side wall;
at least one board containing a plurality of solid-state lighting elements located between the lens and the base tray panel of the lens tray; and,
at least one sealing element adjacent the outer edge.

2. The canopy light fixture of claim 1, wherein the diffuser lens is secured to the lens tray by fasteners extending through the outer edge of the diffuser lens into engagement with the base tray panel of the lens tray.

3. The canopy light fixture of claim 1, wherein an access opening, spaced from the side wall, is formed in the base tray panel.

4. The canopy light fixture of claim 1, wherein the first hole is internally threaded.

5. The canopy light fixture of claim 1, wherein the at least one sealing element is a continuous gasket formed to extend along a full length of the outer edge of the diffuser lens.

6. The canopy light fixture of claim 1, wherein the housing includes at least one sealing element bounding the top opening configured to be in sealing contact with the lens tray with the lens tray in the first position.

7. The canopy light fixture of claim 1, wherein the housing includes one or more access openings extending through at least one of the base panel, the first side panel, the second side panel, the third side panel, and the fourth side panel into communication with the interior volume.

8. The canopy light fixture of claim 1, wherein the second side panel is located opposite the first side panel across the base panel.

9. A solid-state canopy light fixture apparatus, comprising:
a box-shaped housing including:
a base panel;
a first side panel;
a second side panel;
a third side panel; and
a fourth side panel,
wherein the base panel and the first, second, third, and fourth side panels collectively define an interior volume and a top opening spaced from the base panel for access to the interior volume;
the housing further including:
a hinge member formed on an exterior surface of the first side panel; and
a rib projecting from an exterior surface of the second side panel, the rib defining a first opening sized to receive a fastener;
a lens tray mounted to the housing in a manner that allows rotation, the lens tray comprising:
a base tray panel having opposing first and second faces;
a continuous side wall extending from the base tray panel to form a peripheral border;
at least one tray hinge member formed on an exterior surface of the side wall, the tray hinge member being hingedly coupled to the hinge member of the housing to permit rotation of the lens tray; and
a tray rib formed on the exterior surface of the side wall and including a second opening configured to align with the first opening when the lens tray is in a closed position and to be out of alignment when the lens tray is rotated to an open position;
a diffuser lens secured to the lens tray, the diffuser lens having a generally planar outer edge entirely recessed within the side wall;
at least one board carrying a plurality of solid-state lighting elements, the board being disposed between the diffuser lens and the base tray panel; and
a sealing element positioned adjacent the outer edge of the diffuser lens for inhibiting an ingress of moisture.

10. The solid-state canopy light fixture apparatus of claim 9, wherein the diffuser lens is secured to the lens tray by fasteners extending through an outer edge of the diffuser lens into engagement with the base tray panel.

11. The solid-state canopy light fixture apparatus of claim 9, further comprising an access opening formed in the base tray panel, the access opening being spaced from the continuous side wall.

12. The solid-state canopy light fixture apparatus of claim 9, wherein the housing further includes at least one sealing element bounding the top opening and configured to be in sealing contact with the lens tray when the lens tray is in a closed position.

13. The solid-state canopy light fixture apparatus of claim 9, wherein the second side panel is positioned opposite the first side panel across the base panel.

14. The solid-state canopy light fixture apparatus of claim 9, further comprising a fastener removably received in the first opening of the rib and the second opening of the tray rib when the lens tray is in the closed position to secure the lens tray to the housing.

15. The solid-state canopy light fixture apparatus of claim 9, wherein the hinge member and the tray hinge member are interconnected via a pin configured with a locking detent to resist withdrawal of the pin from a corresponding pin opening.

16. The solid-state canopy light fixture apparatus of claim 9, wherein the board is positioned wholly within an inner portion of the diffuser lens.
